(19) United States
(12) Patent Application Publication
(10) Pub. No.: US 2026/0071923 A1
(43) Pub. Date: Mar. 12, 2026

(54) FORCE SENSING GLOVE INCLUDING TEXTILE EMBEDDED PRESSURE SENSING

(71) Applicant: ANSELL LIMITED, Richmond, Victoria (AU)

(72) Inventors: Carrie Lirae MERCK, Taylors, SC (US); Eric Michael THOMPSON, Central, SC (US); James Patrick THOMPSON, Pendleton, SC (US); Bryce BEAMER, Albion, NY (US); James Hunter MORELAND, Central, SC (US); David Emilio MARCUS, Satellite Beach, FL (US); Morey Robert Samuel AGNEW, Honea Path, SC (US); Edgar PAYAN ZUBIA, Ciudad Juarez, Chihuahua (MX); Adrian Fernando SANCHEZ TORRES, Ciudad Juárez, Chihuahua (MX)

(21) Appl. No.: 19/105,849

(22) PCT Filed: Aug. 25, 2023
(86) PCT No.: PCT/AU2023/050824

§ 371 Date: Feb. 24, 2025

Related U.S. Application Data
(60) Provisional application No. 63/400,967, filed on Aug. 25, 2022.

(51) Int. Cl. G01L 1/08

(52) U.S. Cl. CPC G01L 1/083

(57) ABSTRACT

Embodiments of a force sensor for a textile are provided where the sensor comprises: a tube having a compression portion and a transmission portion extending from the compression portion, the compression portion being routed into a sensing area fill geometry configured to receive a force applied to the textile in which the tube is embedded, the transmission portion comprised of a compression-resistant material, and the compression portion comprised of a compressible material; an electronic pressure sensing element fluidly coupled to the tube and spaced from the compression portion by the transmission portion, the electronic pressure sensing element configured to measure pressure exerted on the compression portion through the textile; and a fluid within the tube.

### BACKGROUND

### Field of the Invention

Embodiments of the present invention relate generally to protective articles and, more particularly, to wearable hand motion and force tracking and feedback systems.

### Description of the Related Art

Gloves are used in many industries and in households. Many activities are of a repetitive nature, which can cause or exacerbate hand and wrist musculoskeletal disorders (MSDs), such as lateral epicondylitis and carpal tunnel syndrome and musculo-skeletal disease. Increasing force applications will also increase the risk of a distal upper extremity outcome, and the longer a person engages in activities using the hand, the more tired the hand can become.

Hand and wrist Work-related Musculoskeletal Disorders (WMSDs) represent a substantial proportion of work-related injuries and are associated with relatively high medical costs and loss of work. Repetitive tasks of the hand have a high-risk of hand disorders, namely carpal tunnel syndrome and wrist tendinopathy. WMSDs are associated with work patterns that include repetitive motion, concentrated forces and fixed or constrained positions. The main cause for De Quervain's tendinosis disease is forceful gripping and repetitive hand twisting. Point and whole hand forces for complex hand motions are challenging to quantify and monitor.

### SUMMARY

Embodiments of the present disclosure generally relate to a wearable system for measuring and tracking hand and wrist motion and forces, and providing quantification, instruction, monitoring or corrective feedback to minimize or prevent injuries and WMSDs, substantially as shown and described in connection with at least one of the figures is provided.

In some embodiments, a force sensor for a textile includes: a tube having a compression portion and a transmission portion extending from the compression portion, the compression portion being routed into a sensing area fill geometry configured to receive a force applied to the textile in which the tube is embedded, the transmission portion comprised of a compression-resistant material, and the compression portion comprised of a compressible material; an electronic pressure sensing element fluidly coupled to the tube and spaced from the compression portion by the transmission portion, the electronic pressure sensing element configured to measure pressure exerted on the compression portion through the textile; and a fluid within the tube.

In some embodiments, a pressure sensitive textile includes: a textile having a first surface and a second surface opposite the first surface, the textile defining a compression zone for receiving a force applied to the textile; a sensor disposed at least partially within the textile between the first and second surfaces, the sensor comprising: a tube having a compression portion and a transmission portion extending from the compression portion, the compression portion being routed into a sensing area fill geometry aligned with the compression zone and configured to receive the force via the textile, the transmission portion comprised of a compression-resistant material, and the compression portion comprised of a compressible material; an electronic pressure sensing element fluidly coupled to the tube and spaced from the compression portion by the transmission portion, the electronic pressure sensing element configured to measure pressure exerted on the compression portion through the textile; and a fluid within the tube.

In some embodiments, a force measurement glove includes: a glove comprising a textile having a palm and a plurality of finger sleeves extending from the palm, the textile having a first surface and a second surface opposite the first surface, the textile defining a compression zone for receiving a force applied to the textile; at least one sensor disposed at least partially within the textile between the first and second surfaces, the sensor comprising: a tube having a compression portion and a transmission portion extending from the compression portion, the compression portion being routed into a sensing area fill geometry aligned with the compression zone and configured to receive the force via the textile, the transmission portion comprised of a compression-resistant material, and the compression portion comprised of a compressible material; an electronic pressure sensing element fluidly coupled to the tube and spaced from the compression portion by the transmission portion, the electronic pressure sensing element configured to measure pressure exerted on the compression portion through the textile; and a fluid within the tube.

Various advantages, aspects and novel and inventive features of the present disclosure, as well as details of illustrative embodiments thereof, will be more fully understood from the following description and drawings. The foregoing summary is not intended, and should not be contemplated, to describe each embodiment or every implementation of the embodiments. Other and further embodiments of the present disclosure are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a glove with sensors at various sensor locations in accordance with some embodiments of the present disclosure.

FIG. 2 depicts a glove with sensors at various sensor locations in accordance with some embodiments of the present disclosure.

FIG. 3 depicts a glove with pneumatic sensors and module with module dock (receptacle) in accordance with some embodiments of the present disclosure.

FIG. 4 depicts an exploded view of a glove in accordance with some embodiments of the present disclosure.

FIG. 5 depicts an exploded view of a pneumatic module with pneumatic connectors (manifold) in accordance with some embodiments of the present disclosure.

FIG. 6 depicts a module docking connection using a dovetail connection in accordance with some embodiments of the present disclosure.

FIG. 7A depicts a force sensor for a textile in accordance with some embodiments of the present disclosure.

FIG. 7B depicts the force sensor of FIG. 7A viewed along the linear along section 7B-7B in FIG. 7A.

FIG. 8A-8B depict linear detection areas in accordance with some embodiments of the present disclosure.

FIGS. 9A-9B depict spiral detection areas in accordance with some embodiments of the present disclosure.

### DETAILED DESCRIPTION

Before describing embodiments of the present invention in detail, the terminology used herein is for the purpose of describing particular embodiments only, and is not intended to be limiting. The invention should not necessarily be limited to specific compositions, materials, designs or equipment, as such may vary. All technical and scientific terms used herein have the usual meaning that is conventionally understood by persons skilled in the art to which embodiments of this invention pertain, unless context defines otherwise. Also, as used in this specification and the appended claims, the singular forms “a,” “an,” and “the” may include plural referents unless the context clearly dictates otherwise.

Embodiments of the present disclosure may advantageously be used to minimize risk of injury, including injuries because of applied forces (e.g., magnitude, duration, etc.) or repetitive motions. Embodiments of the present disclosure can also be advantageously used for characterization of motion profiles that lead to injury. Embodiments of the present disclosure may advantageously be used to enhance productivity and ergonomics.

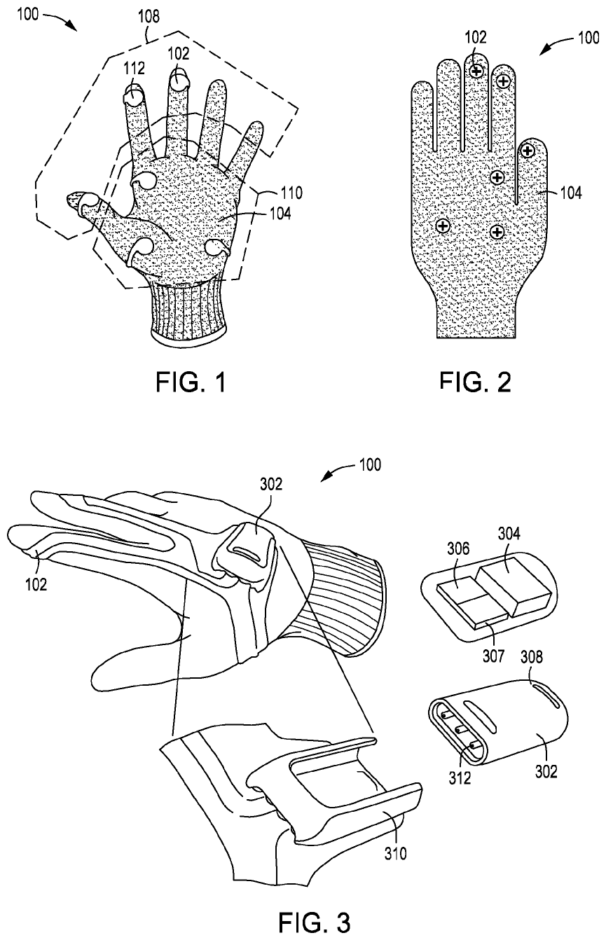

In some embodiments, and as shown in FIGS. 1 and 2, Force Sensing Industrial Gloves (FSIG) 100 include force or pressure sensors 102 located on the fingers, hands, or palms of a glove 104 to quantify the strain on the worker or individual. The sensors 102 are located on the glove 104 at compression zones 112. The sensors 102 are configured to receive force or pressure at the compression zones 112. In some embodiments, the sensors 102 can be integrated into the glove 104, as an insert to existing gloves, or through a zonal textile covering, glue lamination, textile panel sewing, or other integration method forming a glove-sensor assembly 106. Embodiments sensors embedded in a textile are described in greater detail below.

Numerous sensor technologies may be integrated based on functional needs and durability, including, but not limited to force sensitive resistors (FSR), capacitive force sensors, pneumatic/hydraulic/fluid pressure sensors, inductive sensors, strain gauges, or other sensor types. Sensor materials may be comprised of textile, 3D printed or laminated layered structures. In some embodiments, and as shown in FIGS. 1 and 2, sensors 102 can be located at fingertips 108, on the palm 110, or other areas in active grip zone of the palm or fingers, having multiple separate sensors or arrayed sensing zones.

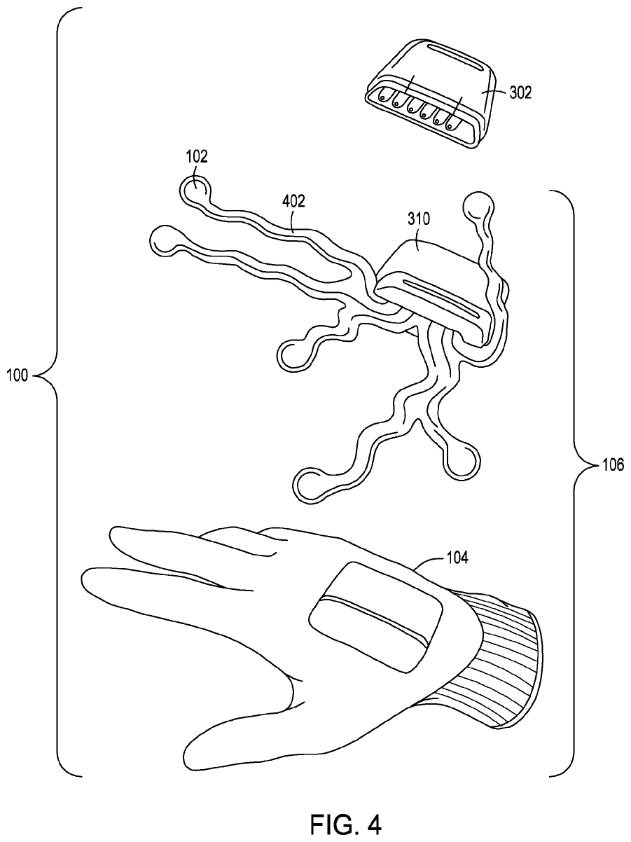

In some embodiments, and as shown in FIGS. 3 and 4, the sensors 102 mounted onto the glove 104 may be connected to a control unit 302, inclusive of power source 304 (e.g., battery), sensor electronics 306 and/or communication electronics 307 for connectivity for transferring data captured from the sensors 102, and a housing 308. In some embodiments, the data transfer may be through wired or wireless connection, such as Bluetooth, Wi-Fi, or other method. In some embodiments, the data transfer may be real-time or delayed. The FSIG 100 may or may not include other sensor type integrations, for example motion sensors, heat sensors, vibration sensors.

In some embodiments, and as shown in FIGS. 3 and 4, the control unit 302 may be designed for removal from the glove-sensor assembly 106 to allow for cleaning, charging, or other maintenance and replacement user needs. Control units 302 may be charged individually or as a group in a charging tower (not shown).

In some embodiments, sensitive pressure-sensing electronics may be located remotely from the point of compression or force application, which can offer advantages from both durability and cost perspectives when compared to other sensing technologies, specifically in the consumable product market sector. For example, by locating the sensor electronics 306 in control unit 302 rather than at the compression zone 112 (e.g., at a tip of a finger in FIG. 1), the sensor electronics 306 may not need to be replaced with the glove-sensor assembly 106. That is, locating sensors 102 away from control unit 302 may allow for reusability of the control unit 302 even if the glove-sensor assembly 106 is consumed. Furthermore, the integration methodology could make the product more robust and flexible.

The control unit 302 may be connected to the glove-sensor assembly 106 in various ways. In some embodiments, and as shown in FIGS. 3 and 4, the control unit 302 may connect (e.g., removably) to the glove-sensor assembly 106 by interfacing with a receptacle 310 of the glove-sensor assembly 106 to make connection (e.g., electrical connection, pneumatic connection, hydraulic connection) between the sensors 102 and the control unit 302. In some embodiments, and as shown in FIG. 6, one connection may include a dovetail connection 602. In some embodiments, a keyhole latch connection, a quarter turn connection, a twist connection, and a rail snap connection may be used to attach the control unit 302 to the receptacle 310. Such connections may be configured to physically secure the glove-sensor assembly 106 to the control unit 302 while accomplishing the functional connections between the sensors 102 and the control unit 302. Thus, multiple pneumatic or hydraulic connections, such as to connectors 312, or electronic connections, may be made by securely connecting the control unit 302 to the glove-sensor assembly 106.

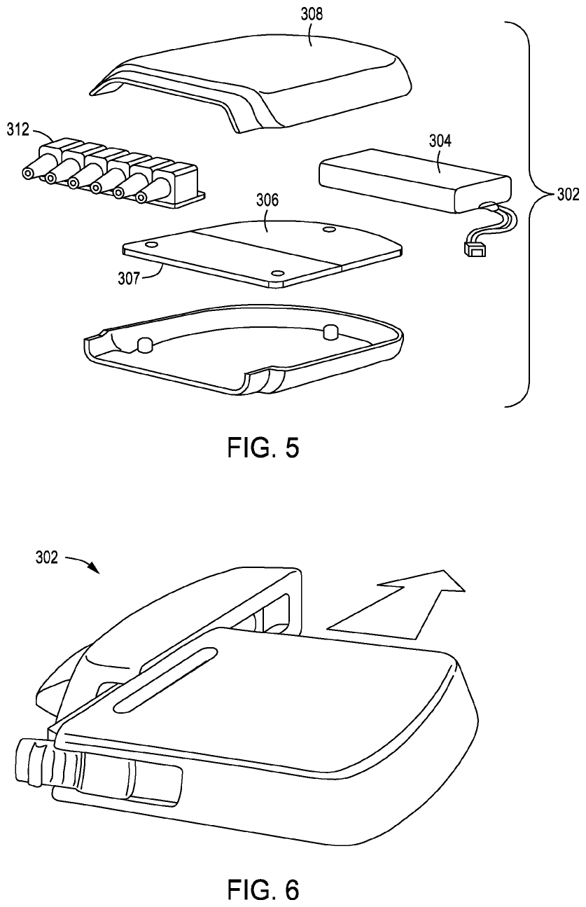

FIG. 5 shows an exploded view of an embodiment of the control unit 302. In some embodiments, the control unit 302 includes housing 308 that houses the power source 304 (e.g., a battery), the sensor electronics 306 and/or communication electronics 307, and one or more connectors 312. In some embodiments, the connectors 312 are configured to connect to the sensors 102 and/or to the sensor electronics 306 to route sensor signals to the sensor electronics 306. In some embodiments, the connectors 312 may be molded or 3D printed. The sensor electronics 306 may be configured to receive at least one of pneumatic, hydraulic, or electronic signals from the sensors 102 and generate a sensor measurement, such as force, pressure, or strain. In some embodiments, and as shown in FIG. 5, the connectors 312 may be arranged as a fluid manifold connector that may be configured to connect (e.g., removably) to a mating pneumatic or hydraulic connector of the glove-sensor assembly 106. In some embodiments, the mating pneumatic or hydraulic connector may be inside the receptacle 310.

In some embodiments, and as shown in FIG. 4, each sensor 102 may pneumatically, hydraulically, or electrically connect with sensor lines 402 to a corresponding connector in the receptacle 310. In some embodiments where a sensor 102 is hydraulic or pneumatic, the sensor line 402 may be a tube configured to carry a fluid (e.g., liquid or gas). In some embodiments where the sensor 102 is hydraulic, the sensor line 402 may include a check valve (e.g., at the receptacle 310) to close the respective sensor line 402 when the control unit 302 is disconnected from the receptacle 310 to prevent leakage of hydraulic fluid from the sensor line 402. In some embodiments where a sensor 102 is an electronic sensor, the sensor line 402 may be a wire.

In some embodiments, and as shown in FIG. 4, at least one of the sensor lines 402 or sensors 102 may be configured to be routed along and attached to internal or external portions of the glove 104. In some embodiments, at least one of the sensor lines 402 or sensors may be embedded in one or more layer of the glove 104.

In some embodiments, the hand motion/force data collected may be used to identify activity trends in real time and/or over a period of time. Various assessments can be made for an individual user or group of users wearing the glove. In some embodiments, the hand motion/force information may be used to calculate a risk assessment score and/or a force score for a user or group of users. In some embodiments, these calculations can be done in the cloud or on the device using machine learning or Al algorithms. Other uses for the embodiments described herein include control systems, assistive devices, VR, and robotics. Specifically, in some embodiments, the FSIG 100 may also be used to actuate assistive grip technology to further reduce worker strain.

### Textile Embedded Pressure Sensing

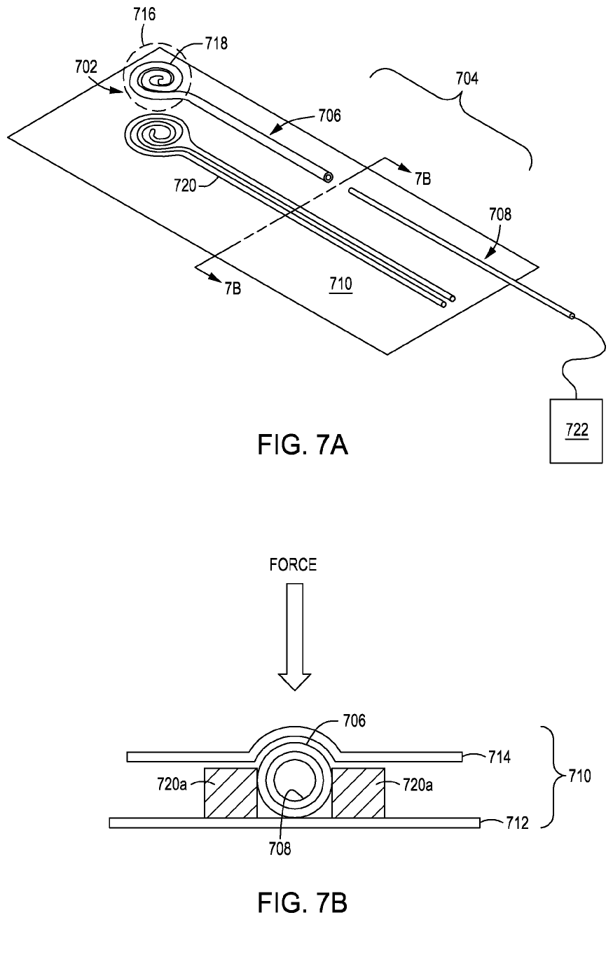

FIG. 7A shows a textile embedded pressure sensor 702 in accordance with some embodiments of the disclosure. As discussed above, in some embodiments, textile embedded pressure sensing may be used to implement some embodiments of the FISG 100. In some embodiments, textile embedded pressure sensing may be used to detect pressure on the user's hand, wrist, arms, body parts, etc. Using elastomeric routing channel technology and through the inclusion of sealed sensor volumes, low-cost and durable sensors can be integrated into textile products, such as gloves or other articles of clothing. Sensors can be tuned for size, shape, and response characteristic by modifying one or more features such as, a tube and/or the routing channels, which are described in greater detail hereinbelow.

In some embodiments, and as shown in FIG. 7A, the sensor 702 may include a tube 704 having a compression portion 706 and a transmission portion 708 extending from the compression portion 706. In some embodiments, the sensor 102 described herein may be configured as the compression portion 706 and the sensor lines 402 may be configured as the transmission portion 708. As described in greater detail herein, the tube 704 may be at least partially disposed in a routing channel 720 attached to a textile 710. In some embodiments, the tube 704 may be fluidly coupled to a control unit 722, which may be the same as control unit 302.

In some embodiments, and a shown in FIG. 7B, the tube 704 may be disposed at least partially in a textile 710 having a first surface or layer 712 and a second surface or layer 714 (shown removed for clarity of illustration) opposite the first surface or layer 712. The first surface or layer 712 and the second surface or layer 714 may be spaced apart by the tube 704 and/or routing channel 720. In some embodiments, and as shown in FIG. 7B, the tube 704 may be at least partially disposed between the first surface or layer 712 and the second surface or layer 714 and thus may be considered to be at least partially embedded in the textile 710.

The textile 710 may be at least partially formed from a garment (e.g., a glove 104) or may be a separate piece that can be attached, with the tube 704, to a garment, such as by sewing, gluing, or using other methods of attachment. Thus, in some embodiments, the tube 704 and textile 710 may be constructed as an assembly that can be bonded or otherwise attached to another textile or fully assembled garment (e.g., such as glove 104) to integrate the sensor 702 into an assembled textile or garment product.

The transmission portion 708 may be comprised of a compression-resistant material (e.g., PTFE), and the compression portion 706 may be comprised of a compressible material (e.g., silicone). In some embodiments, the compression-resistant material has a higher durometer than the compressible material. The transmission portion 708 and the compression portion 706 may have various cross-sectional shapes, such as circular, square, rectangular, triangular, or elliptical, as needed by the specific application of the sensor 702. The sensor 702 may also include a fluid within the tube 704. The fluid may be at least one of a liquid (e.g., water, oil, hydraulic fluid, etc.) or a gas (e.g., air). In some embodiments, the tube 704 is sealed at ends of the tube 704 to contain the fluid within the tube 704.

The routing channel 720 may include guide features 720a extending along sides of the routing channel 720. In some embodiments, and as shown in FIG. 7B, a portion of the second surface or layer 712 may form a bottom of the routing channel 720. In some embodiments, the guide features 720a may be printed or molded and coupled to the textile 710. In some embodiments, the guide features 720a are elastomeric and may be formed of compression-resistant material, such as TPU. In some embodiments, the guide features 720a may be formed from flexible material, such as TPU. In some embodiments the guide features 720a are formed of a material that has a higher durometer than that of the material(s) forming the compression portion 706 of the tube 704. In some embodiments, the guide features 720a may be mechanically connected (e.g., with fasteners or directly connected by interference fit) or chemically bonded (e.g., plastic welded or glued) to the textile 710.

In some embodiments the connection between the compression portion 706 and the transmission portion 708 may be configured to be sealed to prevent fluid leaks from the tube 704. In some embodiments, and as shown in FIG. 7B, the compression portion 706 and the transmission portion 708 may be connected mechanically, such as by an interference fit between an end of the compression portion 706 and an end of the transmission portion 708 (or vice versa) to form an overlapping joint configured to be leak free. In some embodiments, mechanical fluid couplers may be used to make the connection. In some embodiments, the connection may be made chemically, such as by gluing or otherwise bonding (e.g., plastic welding) the ends of the compression portion 706 and the transmission portion 708 together. In some embodiments, a wire may be run through an end of the transmission portion that is overlapped with an end of the compression portion 706 and the region of overlap may be heated (e.g., with a heat gun to mold the compression portion 706 and the transmission portion 708 to each other and around the wire. The wire may be removed once the compression portion 706 and the transmission portion 708 are sealed together.

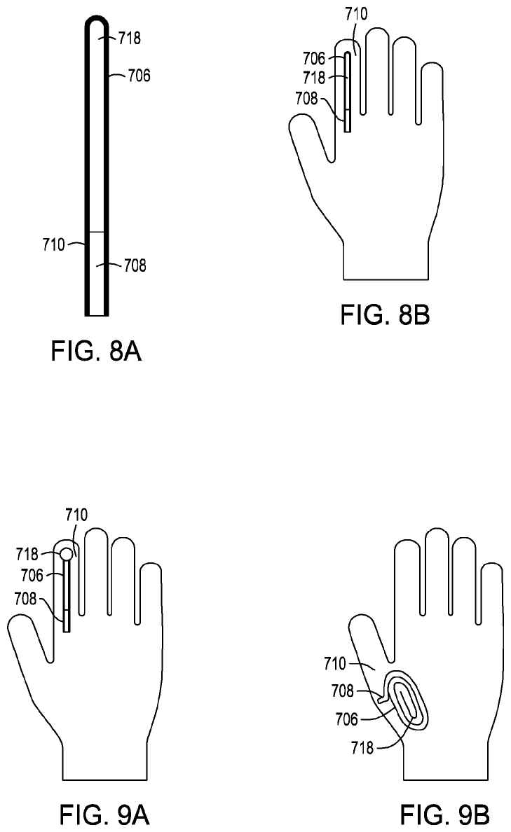

In some embodiments, and as shown in FIGS. 7A and 7B, the textile 710 may define a compression zone 716 around the compression portion 706 for receiving a force applied to the textile 710. The compression portion 706 may be routed into a sensing area fill geometry 718 (e.g., a spiral, as shown in FIGS. 7A, 9A, and 9B, or a straight or curved line, as shown in FIGS. 8A and 8B) located in the compression zone 716 and configured to receive the force applied to the compression zone 716.

In some embodiments, and as shown in FIG. 7A, the routing channel 720 may extend along some or all of the compression portion 706 and define the sensing area fill geometry 718, which is shown as a spiral geometry in FIGS. 7A, 9A, and 9B and as a linear geometry in FIGS. 8A and 8B. The sensing area fill geometry 718 may be surrounded between the first surface or layer 712 and the second surface or layer 714 forming a pocket around the sensing area fill geometry 718 in the compression zone 716. The sensing area fill geometry 718 may have various shapes depending on the arrangement of the compression portion 706 of the tube 704. In some embodiments, and as shown in FIGS. 7A, 9A, and 9B, the sensing area fill geometry 718 may be a round or oblong spiral defining a round or oblong compression zone 716. In some embodiments, and as shown in FIGS. 8A and 8B, the sensing area fill geometry 718 may have a linear shape defining a linear compression zone 716.

Discrete sensor compression zones 716 of the textile 710 may be created by routing the compression portion 706 into the sensing area fill geometries 718 based on sensing needs of a particular application. For example, the spiral fill geometry 718 shown in FIGS. 7A and 9A may be sized and located to sense pressure predominantly at the tip of a finger, while the linear fill geometry 718 shown in FIGS. 8A and 8B may be sized and located to sense pressure along a certain portion of the length of a finger.

In some embodiments the routing channel 720 may extend along some or all of the transmission portion 708 to route the transmission portion 708 to the control unit 722, which may be the same as the control unit 302 described above, and thus may include the sensor electronics 306 for sensing the pressure applied at compression zone 716. In some embodiments, the sensor electronics 306 may be configured to measure pressure or force (represented by arrow in FIG. 7B) exerted through the textile 710 on the part of the compression portion 706 of the tube 704 in the compression zone 716, as shown in FIG. 7B.

In some embodiments, the transmission portion 708 connects at a first end to the compression portion 706 and connects at a second end to the control unit 722 through a manifold (not shown), which may have an interface to connect to sensor electronics (e.g., sensor electronics 306) of the control unit 722. In some embodiments, such a manifold may be molded or 3D printed. In some embodiments, the manifold may be 3D printed using a high temperature resin that may be UV cured. The manifold may have passages or holes to fluidly connect to the second end of the transmission portion 708. In some embodiments, the second end of the transmission portion 708 may be inserted into a hole in the manifold and UV cured along with the manifold. In some embodiments, the second end of the transmission portion 708 in the hole in the manifold may be secured using an adhesive (e.g., cyanoacrylate). In some embodiments, to avoid closing the hole or blocking the second end of the transmission portion 708, a wire may be inserted in the hole and the second end of the transmission portion 708 before applying the adhesive. The first end of the transmission portion 708 may be inserted into the compression portion 706 so that there is an overlap of about 15 mm. A wire may be inserted through the hole in the manifold and through the second end of transmission portion 708 into the area of overlap to prevent collapse of a joint between the compression portion 706 and the transmission portion 708. Heat may be applied to the area of overlap to heat seal the joint between the compression portion 706 and the transmission portion 708. For example, a heat gun (e.g., at 120 C-130 C) may be used to provide heat to seal and mold the compression portion 706 to the transmission portion 708. The wire may be removed when the joint between the compression portion 706 and the transmission portion 708 cools down.

In some embodiments, and as shown in FIG. 7B, in the uncompressed state of the compression portion 706, the outer diameter of the compression portion 706 may be larger than the height of the guide features 720a so that when force is applied to the compression portion 706 in the compression zone 716 through the first surface or layer 714, the compression portion 706 of the tube 704 will be compressed against the guide features 720a, thereby compressing or displacing fluid in the tube 704, which will in-turn, be detected by sensor electronics 306 of the control unit 722 connected to the tube 704. When the force is applied, the force is registered by the sensor electronics 306, with higher forces registering a higher output response from the sensor electronics 306. In some embodiments, when applying a steady force, the output response from the sensor electronics 306 remains steady (e.g., without drift).

The performance and sensitivity of the sensors 102 and 702 described herein may be tuned in many ways, including control sensing area, response curve, response time, and sensing range, which may be performed by at least one of adjusting design parameters such as material and geometric properties of the tube 704, compression zone 716 and sensing area fill geometry 718, material selection and geometry of guide features 720a, or volume of the tube 704.

Although some embodiments have been discussed above, other implementations and applications are also within the scope of the following claims. Although various embodiments herein have been referred to with particularity, it is to be understood that these embodiments are merely illustrative of the principles and applications of the various embodiments. It is therefore to be understood that modifications may be made to the illustrative embodiments and other embodiments may be devised without departing from the spirit and scope of the present disclosure.

Publications and references, including but not limited to patents and patent applications, cited in this specification are herein incorporated by reference in their entireties as if each individual publication or reference were specifically and individually fully set forth herein. Any patent application to which this application claims priority is also incorporated by reference herein in the manner described above for publications and refer.

1. A force sensor for a textile, the sensor comprising:
a tube having a compression portion and a transmission portion extending from the compression portion, the compression portion being routed into a sensing area fill geometry configured to receive a force applied to the textile in which the tube is embedded, the transmission portion comprised of a compression-resistant material, and the compression portion comprised of a compressible material;
an electronic pressure sensing element fluidly coupled to the tube and spaced from the compression portion by the transmission portion, the electronic pressure sensing element configured to measure pressure exerted on the compression portion through the textile; and
a fluid within the tube.

2. The sensor of claim 1, wherein the compression portion is routed into a spiral in a round sensing area fill geometry.

3. The sensor of claim 1, wherein the compression portion is routed along a line in a cylindrical sensing area fill geometry.

4. The sensor of claim 1, further comprising a guide channel extending at least partially around and along the tube.

5. The sensor of claim 4, wherein the guide channel is comprised of an elastomeric material.

6. The sensor of claim 1, wherein the transmission portion is configured to bend without causing a change in the pressure measured by the electronic pressure sensing element.

7. A pressure sensitive textile comprising:
a textile having a first surface and a second surface opposite the first surface, the textile defining a compression zone for receiving a force applied to the textile;
a sensor disposed at least partially within the textile between the first and second surfaces, the sensor comprising:
a tube having a compression portion and a transmission portion extending from the compression portion, the compression portion being routed into a sensing area fill geometry aligned with the compression zone and configured to receive the force via the textile, the transmission portion comprised of a compression-resistant material, and the compression portion comprised of a compressible material;
an electronic pressure sensing element fluidly coupled to the tube and spaced from the compression portion by the transmission portion, the electronic pressure sensing element configured to measure pressure exerted on the compression portion through the textile; and
a fluid within the tube.

8. The pressure sensitive textile of claim 7, wherein the electronic pressure sensing element is not disposed between the first and second surfaces.

9. The pressure sensitive textile of claim 8, wherein the transmission portion extends to the first or second surfaces.

10. The pressure sensitive textile of claim 9, wherein the transmission portion extends to a housing mounted on the first or second surfaces, the housing configured to receive the electronic pressure sensing element.

11. The pressure sensitive textile of claim 10, wherein the housing is a socket and the electronic pressure sensing element is configured to removably connect to the socket.

12. The pressure sensitive textile of claim 7, wherein the textile is a portion of a glove.

13. A force measurement glove comprising:
a glove comprising a textile having a palm and a plurality of finger sleeves extending from the palm, the textile having a first surface and a second surface opposite the first surface, the textile defining a compression zone for receiving a force applied to the textile;
at least one sensor disposed at least partially within the textile between the first and second surfaces, the sensor comprising:
a tube having a compression portion and a transmission portion extending from the compression portion, the compression portion being routed into a sensing area fill geometry aligned with the compression zone and configured to receive the force via the textile, the transmission portion comprised of a compression-resistant material, and the compression portion comprised of a compressible material;
an electronic pressure sensing element fluidly coupled to the tube and spaced from the compression portion by the transmission portion, the electronic pressure sensing element configured to measure pressure exerted on the compression portion through the textile; and
a fluid within the tube.

14. The force measurement glove of claim 13, wherein the compression zone is located at least one of a finger tip or palm of the glove.

15. The force measurement glove of claim 13, wherein the transmission portion extend along at least one of the finger sleeves or the palm.

16. The force measurement glove of claim 14, wherein the compression portion is routed into a spiral in a round sensing area fill geometry.

17. The force measurement glove of claim 14, wherein the compression portion is routed along a line in a cylindrical sensing area fill geometry.

18. The force measurement glove of claim 13, further comprising a guide channel extending at least partially around and along the tube.

19. The force measurement glove of claim 18, wherein the guide channel is comprised of an elastomeric material.

20. The force measurement glove of claim 18, wherein the guide channel is configured for direct connection to the textile.

21. The force measurement glove of claim 13, further comprising one or more motion sensors configured to collect motion data used for characterization of motion profiles that lead to injury.
